(19) United States
(12) Patent Application Publication
(10) Pub. No.: US 2017/0153674 A1
(43) Pub. Date: Jun. 1, 2017

(54) ELECTRONIC DEVICE AND COVERING DEVICE

(71) Applicant: Chiun Mai Communication Systems, Inc., New Taipei (TW)

(72) Inventor: KO-HAN LEE, New Taipei (TW)

(21) Appl. No.: 15/010,421

(22) Filed: Jan. 29, 2016

(30) Foreign Application Priority Data
Nov. 30, 2015 (CN) 201510855810.X

(51) Int. Cl. G06F 1/16; G06F 3/0488; G06F 3/02

(52) U.S. Cl. CPC G06F 1/1677; G06F 3/02; G06F 1/1692; G06F 3/04886

(57) ABSTRACT

An electronic device includes at least one processor and a storage device that stores one or more programs. When the at least one processor executes the one or more programs, the at least one processor is caused to: obtain sensing data from a sensing unit of a covering device, wherein the sensing data includes a bending position of the covering device and a bending degree of the bending position; determine an operation received by the covering device according to the sensing data; and trigger corresponding processing of the electronic device according to the received operation.

### CROSS-REFERENCE TO RELATED APPLICATIONS

This application claims priority to Chinese Patent Application No. 201510855810.X filed on Nov. 30 2015, the contents of which are incorporated by reference herein.

### FIELD

The subject matter herein generally relates to electronic devices, and particularly to an electronic device and a covering device.

### BACKGROUND

Generally, an electronic device such as a mobile phone is configured with a display device. However, as the display device is in a small size, it is not convenient for a user to read content displayed on the display device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device and a covering device.

FIG. 2 is a block diagram of another embodiment of the covering device.

FIG. 3 illustrates one example of different positions on the covering device.

FIG. 4A illustrates one example of the electronic device located on an internal surface of the covering device.

FIG. 4B illustrates one example of the electronic device located on an external surface of the covering device.

FIG. 5 illustrates a flowchart of one embodiment of a method for controlling the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

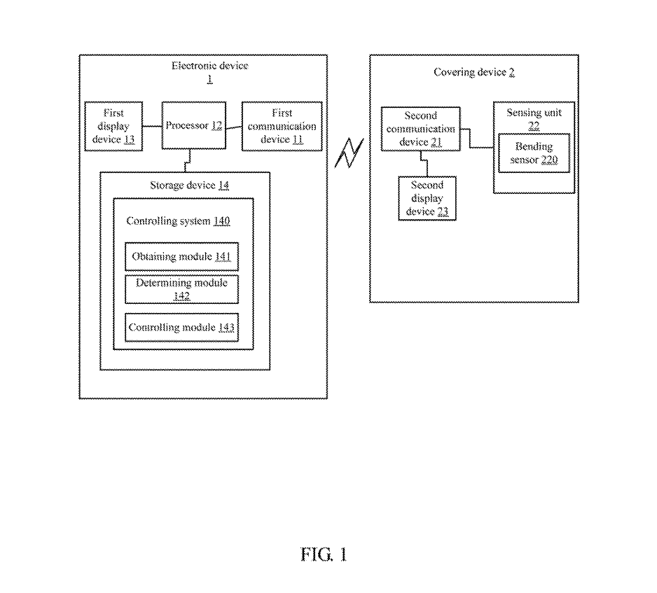

FIG. 1 is a block diagram of one embodiment of an electronic device and a covering device. Depending on the embodiment, an electronic device 1 can dismoutably connect with a covering device 2. The electronic device 1 and the covering device 2 can wirely or wirelessly communicate with each other using a first communication device 11 and a second communication device 21. In at least one embodiment, the covering device 2 can be a protective sleeve of the electronic device 1, the covering device 2 may have a normal size similar to the protective sleeve generally used. In other embodiments, the covering device 2 can be an electronic book that can be bent.

In at least one embodiment, the electronic device 1 can further include, but are not limited to, at least one processor 12, a first display device 13, and a storage device 14. The above components of the electronic device 1 are electrically connected with each other. The electronic device 1 can be a smart phone, a personal digital assistant (PDA), a tablet computer, or any other suitable electronic device. FIG. 1 illustrates only one example of the electronic device 1 that can include more or fewer components than illustrated, or have a different configuration of the various components in other embodiments.

The at least one processor 12 can be a central processing unit (CPU), a microprocessor, or other data processor chip that performs data processing functions of the electronic device 1.

The first display device 13 can be used to display various kinds of information of the electronic device 1. The first display device 13 can provide an interaction interface used for interaction between a user and the electronic device 1.

The storage device 14 can be an internal storage device, such as a flash memory, a random access memory (RAM) for temporary storage of information, and/or a read-only memory (ROM) for permanent storage of information. The storage device 14 can also be an external storage device, such as an external hard disk, a storage card, or a data storage medium.

In at least one embodiment, the covering device 2 includes a sensing unit 22, the sensing unit 22 can be used to sense a bending position of the covering device 2 and a bending degree of the bending position. The sensing unit 22 can be disposed on an internal surface or an external interface of the covering device 2 according to user's requirement. In at least one embodiment, the internal surface can be defined as one surface of the covering device 2 used to cover the electronic device 1. In contrary, another surface of the covering device 2 that is opposite to the internal surface can be defined as the external surface.

In at least one embodiment, the sensing unit 22 includes a bending sensor 220. The size of the bending sensor 220 is the same as the size of the covering device 2. The bending sensor 220 can sense the bending position of the covering device 2 and the bending degree of.

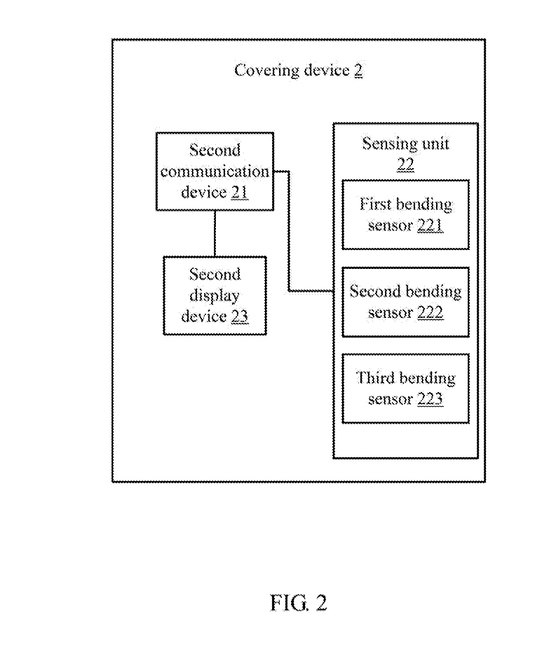

In other embodiments, as shown in FIG. 2, the sensing unit 22 includes three bending sensors, such as a first bending sensor 221, a second bending sensor 222, and a third bending sensor 223. Each of the three bending sensors can have a small size. In other embodiments, each of the second bending sensor 222 and the third bending sensor 223 can be a gravity sensor or a gyroscope sensor.

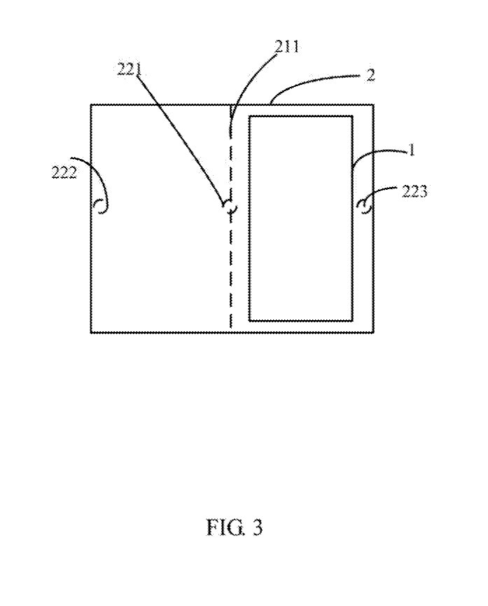

As shown in FIG. 3, the first bending sensor 221 can be disposed at a middle position of the covering device 2. For example, the middle position can be an intersection point of two diagonal lines of the covering device 2 as shown in FIG. 3. The first bending sensor 221 can be used to sense the bending degree of the middle position of the covering device 2. The second bending sensor 222 can be disposed at a left position of the covering device 2, such as at a left margin of the covering device 2 as shown in FIG. 3, for example. The second bending sensor 222 can be used to sense the bending degree of the left position of the covering device 2. The third bending sensor 223 can be disposed at a right position of the covering device 2. For example, the right position can be a position that is located on a right margin of the covering device 2 as shown in FIG. 3. The third bending sensor 223 can be used to sense the bending degree of the right position of the covering device 2. The person has an ordinal skill can understand that because the three bending sensors are disposed at different positions of the covering device 2, so when a bending degree is obtained from one of the three bending sensors, the bending position corresponds to the obtained bending degree is obtained at the same time.

In at least one embodiment, the middle position, the left position, and the right position of the covering device 2 can be defined based on a middle line 211 of the covering device 2. For example, the left position can be defined as a position that is located on a left side of the middle line 211. The right position can be defined as a position that is located on a right side of the middle line 211. The middle position can be defined as a position that is located on the middle line 211.

As shown in FIG. 1 and FIG. 2, the covering device 2 can further include a second display device 23. The second display device 23 can be a flexible display or a hard display. For example, the second display device 23 can be an electronic ink (e-ink) display or an active-matrix organic light emitting diode (Amoled) display that uses less electricity than the first display device 13.

In at least one embodiment, the second display device 23 can be disposed on the internal surface or the external surface of the covering device 2 according to user's requirement. When the second display device 23 is the flexible display, the sensing unit 22 can be disposed between the second display device 23 and the covering device 2.

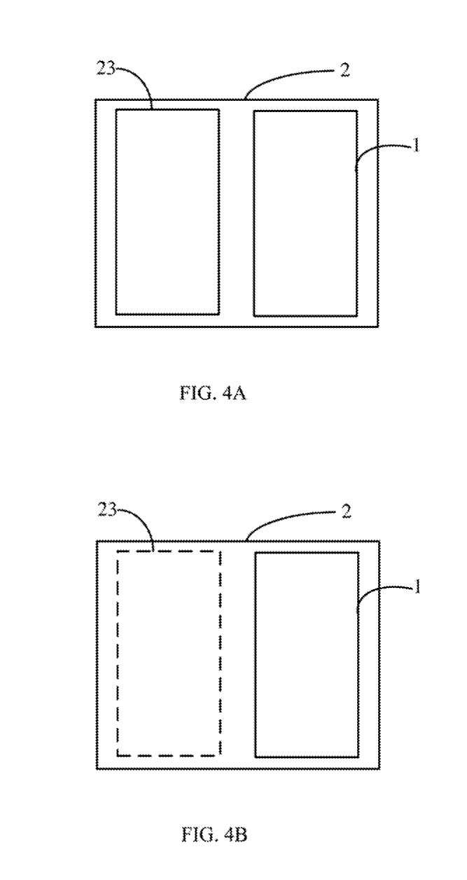

In at least one embodiment, the size of the second display device 23 can be the same as the size of the first display device 13. When the covering device 2 covers the electronic device 1, the second display device 23 can directly face to the electronic device 1. For example, both the second display device 23 and the electronic device 1 can be located on the internal surface of the covering device 2 as shown in FIG. 4A. When the covering device 2 covers the electronic device 1, the second display device 23 can directly face to the electronic device 1. For another example, the second display device 23 can be disposed on the external surface of the covering device 2 as shown in FIG. 4B. When the covering device 2 covers the electronic device 1, the second display device 23 can directly face to the electronic device 1.

In other embodiments, the size of the second display device 23 can be more than or equal to a half of the size of the covering device 2. In one embodiment, the size of the second display device 23 is the same as the size of the covering device 2.

In at least one embodiment, the sensing unit 22 can send sensing data to a controlling system 140 of the electronic device 1 via the second communication device 21. The controlling system 140 can control the electronic device 1 and/or the covering device 2 according to the sensing data. Details will be provided in the following paragraphs.

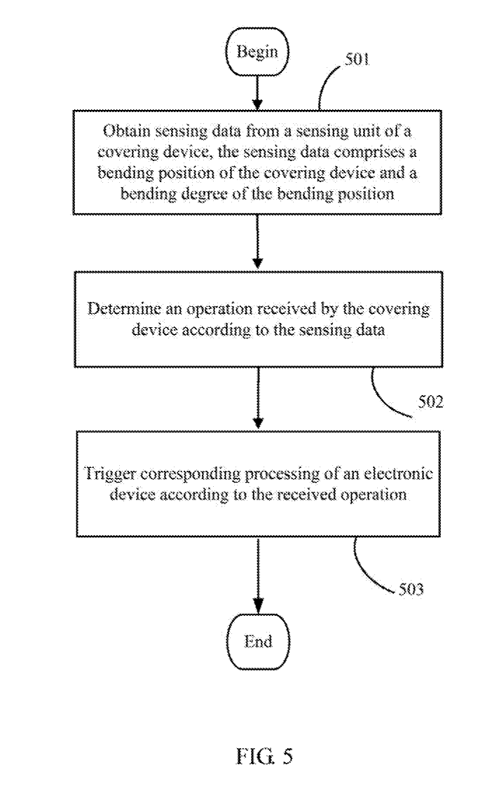

In at least one embodiment, the controlling system 140 can include an obtaining module 141, a determining module 142, and a controlling module 143. The modules 141-143 can include computerized codes in the form of one or more programs, which are stored in the storage device 14, and are executed by the at least one processor 12 of the first electronic device 1 to provide functions of the present invention. Details of functions of the modules will be provided in conjunction with a flow chart of FIG. 5 in the following paragraphs.

FIG. 5 illustrates a flowchart is presented in accordance with an example embodiment. The example method 500 is provided by way of example, as there are a variety of ways to carry out the method. The method 500 described below can be carried out using the configurations illustrated in FIG. 1, for example, and various elements of these figures are referenced in explaining example method 500. Each block shown in FIG. 5 represents one or more processes, methods or subroutines, carried out in the exemplary method 500. Additionally, the illustrated order of blocks is by example only and the order of the blocks can be changed according to the present disclosure. The exemplary method 500 can begin at block 501. Depending on the embodiment, additional steps can be added, others removed, and the ordering of the steps can be changed.

At block 501, the obtaining module 141 can obtain sensing data from the sensing unit 22.

In at least one embodiment, the sensing data can include a bending position of the covering device 2 and a bending degree of the bending position.

At block 502, the determining module 142 can determine an operation received by the covering device 2 according to the sensing data. The covering device 2 can receive the operation from a user passively.

In at least one embodiment, the determining module 142 can pre-define the data ranges corresponding to various operations. Each operation corresponds to a different data range of the sensing data. Upon obtaining the sensing data from the sensing unit 22, the determining module 142 can determine the data range to which the sensing data belongs, and then the determining module 142 can determine a current operation received by the covering device 2 according to the determined data range.

In at least one embodiment, the different operations can include, but are not limited to, an opening operation, a closing operation, a page-turning operation, and/or a folding operation.

In at least one embodiment, when a bending degree of a middle position of the covering device 2 is within a first predetermined data range, the determining module 142 can determine the covering device 2 receives the opening operation from the user. When the bending degree of the middle position of the covering device 2 is within a second predetermined data range, the determining module 142 can determine the covering device 2 receives the closing operation. In at least one embodiment, the second predetermined data range is different from the first predetermined data range.

In at least one embodiment, when a bending degree of a left position or a bending degree of a right position of the covering device 2 is within a third predetermined data range, the determining module 142 can determine the covering device 2 receives the page-turning operation. When a bending degree of a first predetermined position of the left position or a bending degree of a second predetermined position of the right position of the covering device 2 is within a fourth predetermined data range, the determining module 142 can determine the covering device 2 receives the folding operation. In at least one embodiment, the fourth predetermined data range is different from the third predetermined data range.

Similarly, the determining module 142 can pre-define other kinds of operations corresponding to other different bending positions and other different bending degrees. For example, the other kinds of operations may include an rolling operation, and/or a margin turning operation.

At block 503, the controlling module 143 can trigger corresponding processing of the electronic device 1 according to the received operation.

In a first embodiment, the covering device 2 does not include the second display device 23.

When the received operation is the opening operation, the controlling module 143 can activate the first display device 13 of the electronic device 1. When the received operation is the closing operation, the controlling module 143 can inactivate the first display device 13.

When the received operation is the page-turning operation, the controlling module 143 can trigger page-turning operation for content currently displayed on the first display device 13. In at least one embodiment, when the bending degree of the left position of the covering device 2 is within the third predetermined data range, the controlling module 143 can control the first display device 13 to display content of a previous page. When the bending degree of the right position of the covering device 2 is within the third predetermined data range, the controlling module 143 can control the first display device 13 to display content of a next page.

When the received operation is the folding operation, the controlling module 143 can remark or share the content currently displayed on the first display device 13. For example, the controlling module 143 can remark a reading process for the content, remark an emphasis point for the content, make a bookmark for the content, and/or share the content.

In a second embodiment, the covering device 2 further includes the second display device 23, and the second display device 23 is disposed on the external surface of the covering device 2.

When the received operation is the opening operation, and/or the controlling module 143 detects the first display device 13 is in a upside down state using a gravity sensor, the controlling module 143 can activate the second display device 23 to display content for the electronic device 1. In at least one embodiment, the controlling module 143 can further inactivate the first display device 13 to avoid mistakenly touching the first display device 13.

In at least one embodiment, the upside down state can be defined as the first display device 13 rotates with 180 degrees clockwise or counterclockwise based on a normal state.

In at least one embodiment, when the received operation is closing operation, the controlling module 143 can close the first display device 13 and the second display device 23.

The gravity sensor used to detect the state of the first display device 13 can be a gravity sensor of the electronic device 1 or the gravity sensor disposed on the covering device 2.

Similarly to the first embodiment, when the received operation is the page-turning operation or the folding operation, the controlling module 143 can trigger the corresponding processing to the content currently displayed on the first display device 13 or the second display device 23.

In a third embodiment, the second display device 23 is disposed on the internal surface of the covering device 2.

When the received operation is the opening operation, the controlling module 143 can activate the first display device 13 to display content, or can activate both the first display device 13 and the second display device 23 to display content.

When the received operation is the closing operation, the controlling module 143 can inactivate the first display device 13 and the second display device 23.

Similarly to the first embodiment, when the received operation is the page-turning operation or the folding operation, the controlling module 143 can trigger the corresponding processing to the content currently displayed on the first display device 13 or the second display device 23.

It should be noted that, in the second and the third embodiment, the controlling module 143 can also activate or inactivate the second display device 23 when a signal of touching a first predetermined key is received. The first predetermined key can be a physical key of the electronic device 1. The first predetermined key can also be a virtual key displayed on the first display device 13. When the controlling module 143 detects the signal of touching the first predetermined key, the controlling module 143 activate the second display device 23. When the second display device 23 is activated, and the controlling module 123 detects the signal of touching the first predetermined key again, the controlling module 143 can close the second display device 23.

The present disclosure further provides a method for switching display content between the first display device 13 and the second display device 23. In at least one embodiment, the controlling module 143 can switch display content between the first display device 13 and the second display device 23 when a signal of touching a second predetermined key is received. The second predetermined key can be a second physical key of the electronic device 1. It should be noted that the switching display content between the first display device 13 and the second display device 23 can be defined as only one of the two display devices (i.e., the first display device 13 and the second display device 23) is activated to display content at the same time. For example, when the first display device 13 displays content, the switching is defined as inactivating the first display device 13 and activating the second display device 23 to display the content originally displayed by the first display device 13. For another example, when the second display device 23 displays content, the switching is defined as inactivating the second display device 23 and activating the first display device 13 to display the content originally displayed by the second display device 23.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
at least one processor;
a storage device that stores one or more programs that, when executed by the at least one processor, cause the at least one processor to:
obtain sensing data from a sensing unit of a covering device, wherein the sensing data comprises a bending position of the covering device and a bending degree of the bending position;
determine an operation received by the covering device according to the sensing data; and
trigger corresponding processing of the electronic device according to the received operation.

2. The electronic device according to claim 1, wherein the received operation comprises an opening operation, a closing operation, a page-turning operation, and/or a folding operation, and each of the operations corresponds to a different data range of the sensing data.

3. The electronic device according to claim 2, wherein the at least one processor is further caused to:
determine the received operation is the opening operation when a bending degree of a middle position of the covering device is within a first predetermined data range; and
determine the received operation is the closing operation when the bending degree of the middle position is within a second predetermined data range, wherein the second predetermined data range is different from the first predetermined data range.

4. The electronic device according to claim 2, wherein the at least one processor is further caused to:
determine the received operation is the page-turning operation when a bending degree of a left position or a bending degree of a right position of the covering device is within a third predetermined data range; and
determine the received operation is the folding operation when a bending degree of a first predetermined position of the left position or a bending degree of a second predetermined position of the right position of the covering device is within a fourth predetermined data range, wherein the fourth predetermined data range is different from the third predetermined data range.

5. The electronic device according to claim 2, wherein the at least one processor is further caused to:
activate a display device of the electronic device when the received operation is the opening operation;
inactivate the display device of the electronic device when the received operation is the closing operation;
trigger page-turning operation for content currently displayed on the display device of the electronic device when the received operation is the page-turning operation; and
remark or share the content currently displayed on the display device of the electronic device when the received operation is the folding operation.

6. The electronic device according to claim 2, wherein the at least one processor is further caused to:
activate a display device of the covering device when the received operation is the opening operation and/or the display device of the electronic device is in an upside down state.

7. The electronic device according to claim 6, wherein the at least one processor is further caused to:
inactivate the display device of the electronic device if the display device of the covering device is activated.

8. The electronic device according to claim 2, wherein the at least one processor is further caused to:
activate both the display device of the electronic device and the display device of the covering device when the received operation is the opening operation, wherein both the electronic device and the display device of the covering device are located on an internal surface of the covering device; and
inactivate the display device of the electronic device and the display device of the covering device when the received operation is the closing operation.

9. The electronic device according to claim 2, wherein the at least one processor is further caused to:
activate or inactivate the display device of the covering device according to a signal of touching a first predetermined key.

10. The electronic device according to claim 1, wherein the at least one processor is further caused to:
Switch display content between the display device of the electronic device and the display device of the covering device according to a signal of touching a second predetermined key.

11. A covering device comprising a sensing unit, wherein the sensing unit senses a bending position of the covering device and a bending degree of the bending position.

12. The covering device according to claim 11, wherein the sensing unit comprises a bending sensor and a size of the bending sensor is same as a size of the covering device.

13. The covering device according to claim 12, further comprising a display device.

14. The covering device according to claim 13, wherein the display device is a hard display or a flexible display.

15. The covering device according to claim 13, wherein the display device is disposed on an external surface or an internal surface of the covering device.

16. The covering device according to claim 11, wherein the sensing unit comprises a first bending sensor, a second bending sensor, and a third bending sensor, the first bending sensor is disposed at a middle position of the covering device and is used to sense the bending degree of the middle position, the second bending sensor is disposed at a left position of the covering device and is used to sense the bending degree of the left position, the third bending sensor is disposed at a right position of the covering device and is used to sense the bending degree of the right position.

17. The covering device according to claim 16, wherein the middle position, the left position, and the right position are defined based on a middle line of the covering device.

18. The covering device according to claim 16, wherein each of the second bending sensor and the third bending sensor is a gravity sensor or a gyroscope sensor.
